(19) United States
(12) Patent Application Publication
(10) Pub. No.: US 2026/0212454 A1
(43) Pub. Date: Jul. 23, 2026

(54) COLOR DISTORTION-AWARE EXPOSURE FUSION

(71) Applicant: Samsung Electronics Co., Ltd., Suwon-si (KR)

(72) Inventors: Soumendu Majee, McKinney, TX (US); Abhiram Gnanasambandam, Frisco, TX (US); John W. Glotzbach, Allen, TX (US); John Seokjun Lee, Allen, TX (US); Hamid Rahim Sheikh, Allen, TX (US)

(21) Appl. No.: 19/364,969

(22) Filed: Oct. 21, 2025

Related U.S. Application Data
(60) Provisional application No. 63/747,596, filed on Jan. 21, 2025.

(51) Int. Cl. G06T 5/50; G06T 7/00; G06T 7/90

(52) U.S. Cl. CPC G06T 5/50; G06T 7/0002; G06T 7/90; G06T 2207/10024; G06T 2207/10144; G06T 2207/20192; G06T 2207/20221; G06T 2207/30168

(57) ABSTRACT

A method includes obtaining, using at least one processing device of an electronic device, multiple image frames of a scene, where each image frame includes a luma channel and chroma channels. The method also includes blending, using the at least one processing device, the image frames to generate a blended image. Blending the image frames includes determining first weights to be applied when blending the luma channels of the image frames and separate second weights to be applied when blending the chroma channels of the image frames; generating a fused luma image using the luma channels of the image frames and the first weights and separately generating at least one fused chroma image using the chroma channels of the image frames and the second weights; and combining the fused luma image and the at least one fused chroma image.

### CROSS-REFERENCE TO RELATED APPLICATION AND PRIORITY CLAIM

This application claims priority under 35 U.S.C. § 119 (e) to U.S. Provisional Patent Application No. 63/747,596 filed on Jan. 21, 2025, which is hereby incorporated by reference in its entirety.

### TECHNICAL FIELD

This disclosure relates generally to image processing systems and methods. More specifically, this disclosure relates to color distortion-aware exposure fusion.

### BACKGROUND

Many mobile electronic devices, such as smartphones and tablet computers, include cameras that can be used to capture still and video images. These types of devices often include image processing pipelines that perform a number of operations in sequence to generate images of scenes. For example, an image processing pipeline may perform operations that combine multiple image frames of a scene into a combined image and process the combined image to produce a final image of the scene.

### SUMMARY

This disclosure relates to color distortion-aware exposure fusion.

In a first embodiment, a method includes obtaining, using at least one processing device of an electronic device, multiple image frames of a scene, where each image frame includes a luma channel and chroma channels. The method also includes blending, using the at least one processing device, the image frames to generate a blended image. Blending the image frames includes determining first weights to be applied when blending the luma channels of the image frames and separate second weights to be applied when blending the chroma channels of the image frames; generating a fused luma image using the luma channels of the image frames and the first weights and separately generating at least one fused chroma image using the chroma channels of the image frames and the second weights; and combining the fused luma image and the at least one fused chroma image.

In a second embodiment, an electronic device includes at least one processing device configured to obtain multiple image frames of a scene, where each image frame includes a luma channel and chroma channels. The at least one processing device is also configured to blend the image frames to generate a blended image. To blend the image frames, the at least one processing device is configured to determine first weights to be applied when blending the luma channels of the image frames and separate second weights to be applied when blending the chroma channels of the image frames; generate a fused luma image using the luma channels of the image frames and the first weights and separately generate at least one fused chroma image using the chroma channels of the image frames and the second weights; and combine the fused luma image and the at least one fused chroma image.

In a third embodiment, a non-transitory machine readable medium contains instructions that when executed cause at least one processor of an electronic device to obtain multiple image frames of a scene, where each image frame includes a luma channel and chroma channels. The non-transitory machine readable medium also contains instructions that when executed cause the at least one processor blend the image frames to generate a blended image. The instructions that when executed cause the at least one processor to blend the image frames include instructions that when executed cause the at least one processor to determine first weights to be applied when blending the luma channels of the image frames and separate second weights to be applied when blending the chroma channels of the image frames; generate a fused luma image using the luma channels of the image frames and the first weights and separately generate at least one fused chroma image using the chroma channels of the image frames and the second weights; and combine the fused luma image and the at least one fused chroma image.

Any one or any combination of the following features may be used with the first, second, or third embodiment.

The first weights and the second weights may be determined by determining the first weights based on the image frames and modifying the first weights to generate the second weights.

The first weights may be modified by applying an exponential or power-law function to the first weights in order to generate the second weights. The exponential or power-law function may at least one of: reduce first ones of the first weights or increase second ones of the first weights. The first ones of the first weights may have smaller values than the second ones of the first weights. The exponential or power-law function may cause the second weights, compared to the first weights, to favor the chroma channels of one or more first ones of the image frames over the chroma channels of one or more second ones of the image frames during the blending of the image frames. The one or more first ones of the image frames may have a lower exposure than the one or more second ones of the image frames.

The first weights may be modified by determining error maps based on hues of pairs of the image frames and modifying the first weights based on the error maps. In each pair of the image frames, one of the image frames in the pair may have a lower exposure than another of the image frames in the pair.

The first weights and the second weights may be determined by determining the first weights using one or more first tuning parameters and separately determining the second weights using one or more second tuning parameters. The one or more second tuning parameters may be different than the one or more first tuning parameters.

The second weights may be determined using the one or more second tuning parameters by determining different initial weights for the image frames and combining the different initial weights for the image frames to generate the second weights. The different initial weights may be associated with different characteristics of the image frames.

The different initial weights for the image frames may include color saturation weights associated with the image frames. The color saturation weights may be based on amounts of color saturation within the image frames. The different initial weights for the image frames may be combined by at least one of: reducing ones of the initial weights that are associated with larger amounts of color saturation within the image frames or increasing others of the initial weights that are associated with smaller amounts of color saturation within the image frames.

The image frames may include at least one lower-exposure image frame and at least one higher-exposure image frame. The second weights may be determined in order to, during the blending of the image frames, at least one of: (i) increase contribution of the chroma channels of the at least one lower-exposure image frame or (ii) decrease contribution of the chroma channels of the at least one higher-exposure image frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2A and 2B illustrate an example pipeline supporting color distortion-aware exposure fusion in accordance with this disclosure;

FIG. 3 illustrates a first example architecture for color distortion-aware exposure fusion in accordance with this disclosure;

FIGS. 4 and 5 illustrate example techniques for modifying blending maps in the architecture of FIG. 3 in accordance with this disclosure;

FIG. 6 illustrates a second example architecture for color distortion-aware exposure fusion in accordance with this disclosure;

FIG. 7 illustrates an example technique for identifying blending weights for chroma channels in the architectures of FIGS. 3 and 6 in accordance with this disclosure;

FIGS. 8A and 8B illustrate example curves for identifying color saturation weights in the architectures of FIGS. 3 and 6 in accordance with this disclosure;

FIGS. 9A and 9B illustrate example results obtainable using color distortion-aware exposure fusion in accordance with this disclosure; and

FIG. 10 illustrates an example method for color distortion-aware exposure fusion in accordance with this disclosure.

### DETAILED DESCRIPTION

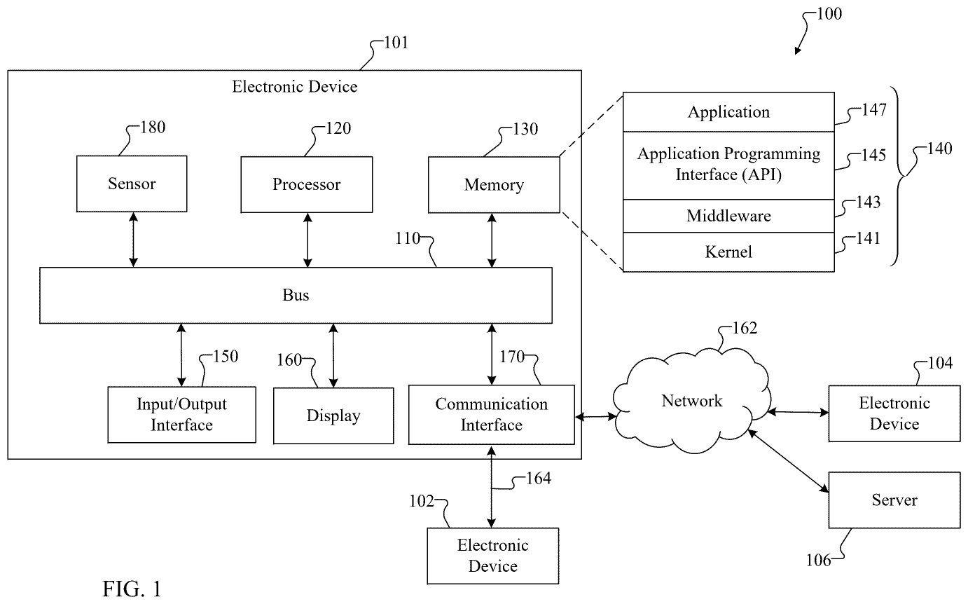

FIGS. 1 through 10, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, many mobile electronic devices, such as smartphones and tablet computers, include cameras that can be used to capture still and video images. These types of devices often include image processing pipelines that perform a number of operations in sequence to generate images of scenes. For example, an image processing pipeline may perform operations that combine multiple image frames of a scene into a combined image and process the combined image to produce a final image of the scene.

One common feature of an image processing pipeline is a tone mapping operation, which can be used to adjust the colors in images produced by the image processing pipeline. Tone mapping can be useful or important in various applications, such as when image processing can result in the creation of unnatural tone within images. One example technique for tone mapping is synthetic exposure fusion-based tone mapping, which generates multiple image frames having different (typically synthetic) exposures and combines the image frames based on a blending map. The blending map can contain blending weights or other values that identify how pixels in different image frames are weighted during the combination of the image frames. One goal of synthetic exposure fusion-based tone mapping can be to combine multiple lower dynamic range image frames into a single image with improved colors.

Unfortunately, existing synthetic exposure fusion-based tone mapping techniques can produce image artifacts in generated images. For example, a wall or other object having substantially-uniform color may appear to have different color tones within a final image of a scene that includes the object. Among other reasons, existing synthetic exposure fusion-based tone mapping techniques use a single set of weights for all data channels of the image frames, which can cause color distortions even with a perfect identification of a blending map. Also, existing techniques for determining blending maps often do not take color distortions into account when determining the blending maps, which can lead to color reproduction issues when processing certain image frames (such as image frames containing colors that are highly saturated in one or more data channels).

Because of these types of color distortion issues, many synthetic exposure fusion-based tone mapping techniques are luma-based, meaning these techniques operate on the luma channels of image frames and not on chroma channels of the image frames. However, these approaches still have issues with color gamut clipping and distortion due to (i) image brightness being too high for a synthetic exposure and/or (ii) color saturation being too high. Simply reducing the contribution of higher-exposure image frames (which tend to suffer from over-saturation due to brightness) may not be effective since there is often a desire to have higher brightness in final output images. Also, reducing the contribution of higher-exposure image frames may be difficult since saturated colors often do not have large luma values, and current synthetic exposure fusion-based tone mapping techniques often favor higher exposures when luma pixels are not saturated.

This disclosure provides various techniques supporting color distortion-aware exposure fusion. As described in more detail below, multiple image frames of a scene can be obtained, and each image frame can include a luma channel and chroma channels. For example, the image frames may be obtained by generating the image frames based on an image produced in an image processing pipeline. In some cases, the image frames can have different (possibly synthetic) exposures. The image frames can be blended to generate a blended image. To blend the image frames, first weights to be applied when blending the luma channels of the image frames can be determined, and separate second weights to be applied when blending the chroma channels of the image frames can be determined. In some cases, the first weights may be based on the image frames, and the first weights may be modified (such as by using an exponential or power-law function and/or hue-based error maps) in order to generate the second weights. A fused luma image can be generated using the luma channels of the image frames and the first weights, such as by blending the luma channels of the image frames based on the first weights. At least one fused chroma image can be separately generated using the chroma channels of the image frames and the second weights, such as by blending the chroma channels of the image frames based on the second weights. The fused luma image and the at least one fused chroma image can be combined to generate a final image of the scene, and one or more post-processing operations may be performed if needed or desired.

In this way, the described techniques can be used to perform color distortion-aware exposure fusion, meaning the described techniques support synthetic exposure fusion-based tone mapping that reduces or avoids problems associated with color distortions. Among other reasons, this can be achieved by supporting different weights for luma and chroma channels of image frames. Also, for chroma-based weighting, separate weighting schemes may be provided for combining chroma channels of different synthetic exposures, such as when higher weights are given to lower-exposure image frames (since there is less color distortion in those image frames). In addition, saturated color detection can be performed, where pixels with saturated colors can be identified and where contributions from higher-exposure image frames for those pixels can be reduced (such as by using lower weights). Because of this, images produced using the described techniques can have significantly-improved quality and significantly-reduced color distortions.

Note that while various embodiments of this disclosure are described in the context of use with certain consumer electronic devices (such as smartphones or tablet computers), this is merely one example. It will be understood that the principles of this disclosure may be implemented in any number of other suitable contexts and may use any suitable device or devices. In general, this disclosure is not limited to use with any specific type(s) or number(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to color distortion-aware exposure fusion.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform color distortion-aware exposure fusion. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to color distortion-aware exposure fusion.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

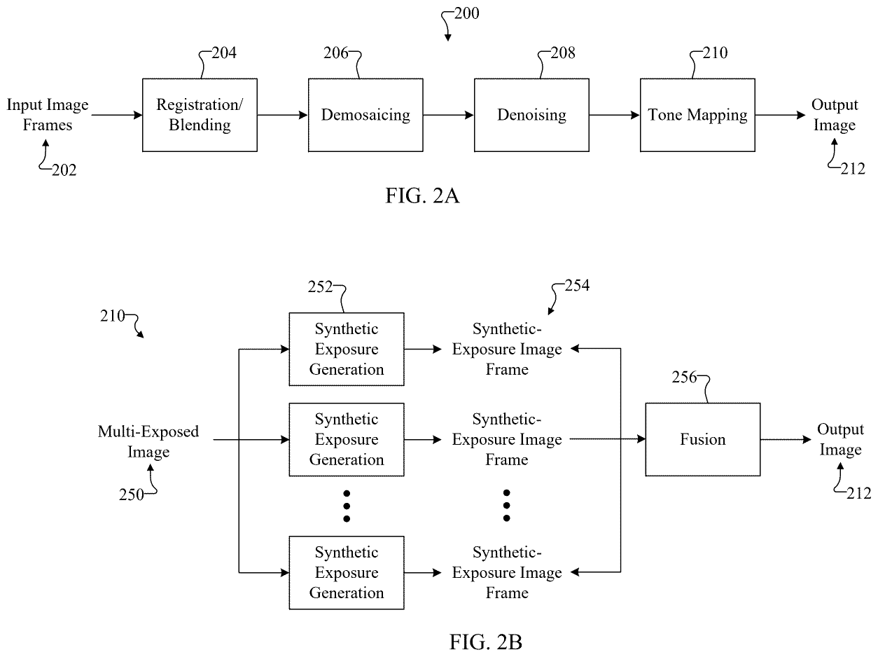

FIGS. 2A and 2B illustrate an example pipeline 200 supporting color distortion-aware exposure fusion in accordance with this disclosure. More specifically, FIG. 2A illustrates the example pipeline 200, and FIG. 2B illustrates one operation within the pipeline 200 in greater detail. For ease of explanation, the pipeline 200 shown in FIGS. 2A and 2B is described as being implemented using the electronic device 101 in the network configuration 100 shown in FIG. 1. However, the pipeline 200 may be implemented using any other suitable device(s) (such as the server 106) and in any other suitable system(s).

As shown in FIG. 2A, the image processing pipeline 200 generally receives and processes input image frames 202. Each input image frame 202 may be obtained from any suitable source, such as when the input image frames 202 are produced by at least one camera or other imaging sensor 180 of the electronic device 101 during an image capture operation. In some embodiments, the input image frames 202 may represent raw image frames. Raw image frames typically refer to image frames that have undergone little if any processing after being captured. The availability of raw image frames can be useful in a number of circumstances since the raw image frames can be subsequently processed to achieve the creation of desired effects in output images. In many cases, for example, the input image frames 202 can have a wider dynamic range or a wider color gamut that is narrowed during image processing operations in order to produce still or video images suitable for display or other use. Each input image frame 202 can have any suitable format, such as a Bayer or other raw image format, a red-green-blue (RGB) image format, or a luma-chroma (YUV) image format. Each input image frame 202 can also have any suitable resolution, such as up to fifty megapixels or more.

In some embodiments, the input image frames 202 may include two or more image frames captured using different capture conditions. The capture conditions can represent any suitable settings of the electronic device 101 or other device used to capture the input image frames 202 or any suitable contents of scenes being imaged. For example, the capture conditions may represent different exposure settings of the imaging sensor(s) 180 used to capture the input image frames 202, such as different exposure times or ISO settings. In multi-frame processing pipelines, for instance, different input image frames 202 can be captured using different exposure settings so that portions of different input image frames 202 can be combined to produce a high dynamic range (HDR) output image or other blended image.

In some embodiments, the input image frames 202 may undergo one or more pre-processing operations prior to further processing in the pipeline 200. Any suitable pre-processing operation(s) may be performed here. Examples of pre-processing operations may include bad pixel correction (identifying and replacing bad pixel data, such as via interpolation of neighboring good pixel data), lens shading correction (compensating for peripheral shading created by one or more lenses used in or with one or more imaging sensors 180), and/or white balance adjustment (modifying the white balance of one or more input image frames 202). Note, however, that this disclosure is not limited to any particular image pre-processing technique(s).

The input image frames 202 (or possibly preprocessed versions thereof) are provided to an image registration and blending operation 204, which generally operates to (i) modify one or more of the input image frames 202 in order to generate aligned versions of the input image frames 202 and (ii) blend or otherwise combine the aligned versions of the input image frames 202. For example, the input image frames 202 may undergo registration so that common features in different input image frames 202 are at the same or substantially the same locations in the aligned versions of the input image frames 202. In some embodiments, registration may be performed by selecting a reference image frame and modifying one or more non-reference image frames so as to be aligned with the reference image frame, such as by generating a warp or alignment map for each non-reference image frame, where each warp or alignment map includes or is based on one or more motion vectors that identify how the position(s) of one or more specific features in the associated non-reference image frame should be altered in order to be in the position(s) of the same feature(s) in the reference image frame. Registration may be needed in order to compensate for misalignment caused by the electronic device 101 moving or rotating in between image captures, which causes objects in the input image frames 202 to move or rotate slightly (as is common with handheld devices). Registration, which is also sometimes referred to as image alignment, may be performed using any suitable technique(s). In some embodiments, the input image frames 202 can be aligned both geometrically and photometrically. In particular embodiments, the registration can be performed using global Oriented FAST and Rotated BRIEF (ORB) features and local features from a block search to identify how to align the image frames. Note, however, that this disclosure is not limited to any particular technique(s) for aligning image frames.

The blending generally operates to combine image data contained in the aligned input image frames 202 in order to generate a blended image. For instance, blending may occur by processing the aligned input image frames 202 in order to modify portions of the selected reference frame using image data from one or more non-reference frames. As a particular example, blending may take the reference frame and replace one or more portions of the reference frame containing motion with one or more corresponding portions of one or more lower-exposure image frames, thereby producing the blended image. In some cases, the blending may involve a weighted blending operation that combines the pixel values contained in the aligned image frames 202 based on weights. Note, however, that this disclosure is not limited to any particular technique(s) for combining image frames.

The blended image is provided to a demosaicing operation 206, which generally operates to convert image data produced using a Bayer filter array or other color filter array into reconstructed red-green-blue (RGB) data or other image data in order to generate a demosaiced image. For example, the demosaicing operation 206 can perform various interpolations to fill in missing information, such as by estimating other colors' image data for each pixel. When using a Bayer filter array or some other types of color filter arrays, approximately twice as many pixels may capture image data using green filters compared to pixels that capture image data using red or blue filters. This can introduce non-uniformities into the captured image data, such as when the red and blue image data each have a lower signal-to-noise ratio (SNR) and a lower sampling rate compared to the green image data. Among other things, the green image data can capture high-frequency image content more effectively than the red and blue image data. The demosaicing operation 206 can take information captured by at least one highly-sampled channel (such as the green channel and/or the white channel) and use that information to correct limitations of lower-sampled channels (such as the red and blue channels), which can help to reintroduce high-frequency image content into the red and blue image data. Note, however, that this disclosure is not limited to any particular technique(s) for demosaicing images.

The demosaiced image is provided to a denoising operation 208, which generally operates to process the demosaiced image and remove noise from the demosaiced image in order to generate a filtered image, such as an HDR image. For example, the denoising operation 208 may be used to remove sampling, interpolation, and aliasing artifacts and noise in subsampled image channels (such as the red and blue channels) of the demosaiced image using information from at least one higher-sampled channel (such as the green channel and/or the white channel) of the demosaiced image. The denoising operation 208 may also or alternatively be used to filter the image data of the demosaiced image in order to remove noise from object edges, which can help to provide cleaner edges to objects captured in the demosaiced image. The denoising operation 208 may use any suitable technique(s) for filtering image data, such as spatial noise filtering. Note, however, that this disclosure is not limited to any particular technique(s) for filtering image data.

The filtered image is provided to a tone mapping operation 210, which generally operates to adjust colors in the filtered image. As noted above, this can be useful or important in various applications, such as when generating HDR images. For instance, since generating an HDR image often involves capturing multiple image frames 202 of a scene using different exposures and combining the captured image frames to produce the HDR image, this type of processing can often result in the creation of unnatural tone within the HDR image. The tone mapping operation 210 can therefore adjust the colors contained in the filtered image, such as by performing dynamic range compression, in order to provide more natural colors or other results. The output of the tone mapping operation 210 can represent an output image 212, which may represent a final image of the scene. Note, however, that the output image 212 may undergo one or more post-processing operations to produce a final image of the scene.

FIG. 2B illustrates an example implementation of the tone mapping operation 210 of the pipeline 200. As shown in FIG. 2B, the tone mapping operation 210 obtains a multi-exposed image 250, such as an HDR image produced by the operations 204-208 in the pipeline 200. In some cases, the multi-exposed image 250 may represent a linear HDR image.

The tone mapping operation 210 performs one or more synthetic exposure generation operations 252 using the multi-exposed image 250 to generate multiple synthetic-exposure image frames 254. Each synthetic-exposure image frame 254 represents a synthetic or machine-generated version of the multi-exposed image 250 at a specified exposure. Different synthetic-exposure image frames 254 represent synthetic or machine-generated versions of the multi-exposed image 250 at different exposures. For example, the synthetic exposure generation operation(s) 252 may operate to produce one or more lower-exposure image frames 254, one or more medium-exposure image frames 254, and one or more higher-exposure image frames 254. Note here that “lower,” “medium,” and “higher” are used relative to each other and do not require any specific values of exposure settings. Lower-exposure image frames are often associated with shorter exposure times and/or faster shutter speeds, medium-exposure image frames are often associated with intermediate exposure times and/or intermediate shutter speeds, and higher-exposure image frames are often associated with longer exposure times and/or slower shutter speeds. Smaller-exposure image frames can often capture details in brighter portions of a scene that would appear “blown out” at higher exposure values (where “blown out” encompasses conditions where light provided by a portion of a scene exceeds an upper limit of a dynamic range of an imaging sensor, resulting in significant or total loss of color saturation). Each synthetic exposure generation operation 252 includes any suitable logic for generating a synthetic image frame at a specified exposure. While multiple instances of the synthetic exposure generation operation 252 are shown in FIG. 2B, the same operation 252 may be used repeatedly (such as serially) to generate the synthetic-exposure image frames 254.

A fusion operation 256 generally operates to fuse or otherwise combine the synthetic-exposure image frames 254 in order to generate an output image 212. Example implementations of the fusion operation 256 are described below. In some embodiments, the fusion operation 256 may perform weighted blending of pixel values in the synthetic-exposure image frames 254 in order to generate pixel values in the output image 212. The fusion operation 256 can also perform weighted blending of luma and chroma channels of the synthetic-exposure image frames 254 separately in order to generate a fused luma image and at least one fused chroma image, which can be combined to produce the output image 212. As described below, the luma and chroma channels of the synthetic-exposure image frames 254 can be weighted differently during the fusion. Also, for chroma-based weighting, separate weighting schemes may be used to combine the chroma channels of the synthetic-exposure image frames 254, such as to give higher weights to synthetic-exposure image frames 254 associated with lower exposures (where there is less color distortion).

The weights used by the fusion operation 256 to combine the luma and chroma channels of the synthetic-exposure image frames 254 can be determined in any suitable manner. For example, in some embodiments, the fusion operation 256 may determine first weights used to combine the luma channels of the synthetic-exposure image frames 254, and at least some of the first weights can be modified in order to generate second weights used to combine the chroma channels of the synthetic-exposure image frames 254. In these embodiments, the first weights could be modified to favor synthetic-exposure image frames 254 having lower exposures over synthetic-exposure image frames 254 having higher exposures under certain circumstances. In particular embodiments, the first weights may be modified by applying an exponential or power-law function to the first weights in order to generate the second weights, where (i) the exponential or power-law function reduces first ones of the first weights and/or increases second ones of the first weights and (ii) the first ones of the first weights have smaller values than the second ones of the first weights. Here, the exponential or power-law function causes the second weights, compared to the first weights, to favor the chroma channels of one or more first ones of the synthetic-exposure image frames 254 over the chroma channels of one or more second ones of the synthetic-exposure image frames 254 during the blending of the synthetic-exposure image frames 254, where the one or more first ones of the synthetic-exposure image frames 254 have a lower exposure than the one or more second ones of the synthetic-exposure image frames 254. As another particular example, the first weights may be modified by determining error maps based on hues of pairs of the synthetic-exposure image frames 254 and modifying the first weights based on the error maps, where each pair of the synthetic-exposure image frames 254 includes an image frame having a lower exposure than the other image frame.

In other embodiments, the fusion operation 256 may determine first weights used to combine the luma channels of the synthetic-exposure image frames 254 and separately determine second weights used to combine the chroma channels of the synthetic-exposure image frames 254. In these embodiments, the first and second weights could be generated using different tuning parameters. For example, initial weights may be determined for the synthetic-exposure image frames 254, such as based on different characteristics of the synthetic-exposure image frames 254. The initial weights for the synthetic-exposure image frames 254 can be combined to generate the first weights used to blend the luma channels of the synthetic-exposure image frames 254. Similar operations may occur to generate the second weights used to blend the chroma channels of the synthetic-exposure image frames 254. Again, in some cases, this can be done to favor synthetic-exposure image frames 254 having lower exposures over synthetic-exposure image frames 254 having higher exposures.

The fusion operation 256 can also identify pixels of the synthetic-exposure image frames 254 associated with or containing saturated colors. For example, color saturation weights associated with the synthetic-exposure image frames 254 can be identified, where the color saturation weights are based on amounts of color saturation within the synthetic-exposure image frames 254. The weights used to combine the luma channels and/or the chroma channels of the synthetic-exposure image frames 254 can be modified based on the color saturation weights, such as by reducing ones of the initial weights that are associated with larger amounts of color saturation within the synthetic-exposure image frames 254 and/or increasing others of the initial weights that are associated with smaller amounts of color saturation within the synthetic-exposure image frames 254. In some cases, this allows contributions from saturated pixels in higher-exposure synthetic-exposure image frames 254 to be reduced, thereby favoring pixels in lower-exposure synthetic-exposure image frames 254, when color saturation is detected.

Although FIGS. 2A and 2B illustrate one example of a pipeline 200 supporting color distortion-aware exposure fusion, various changes may be made to FIGS. 2A and 2B. For example, various components and operations in FIGS. 2A and 2B may be combined, further subdivided, replicated, rearranged, or omitted according to particular needs. Also, various additional components and operations may be used in FIGS. 2A and 2B. In addition, the specific image processing pipeline 200 described above is for illustration and explanation only. Various image processing pipelines have been developed, and additional image processing pipelines are sure to be developed in the future. This disclosure is not limited to any specific implementation of an image processing pipeline or even to use within an image processing pipeline. In general, the techniques for color distortion-aware exposure fusion described in this patent document may be used in any other image processing pipeline or other architecture.

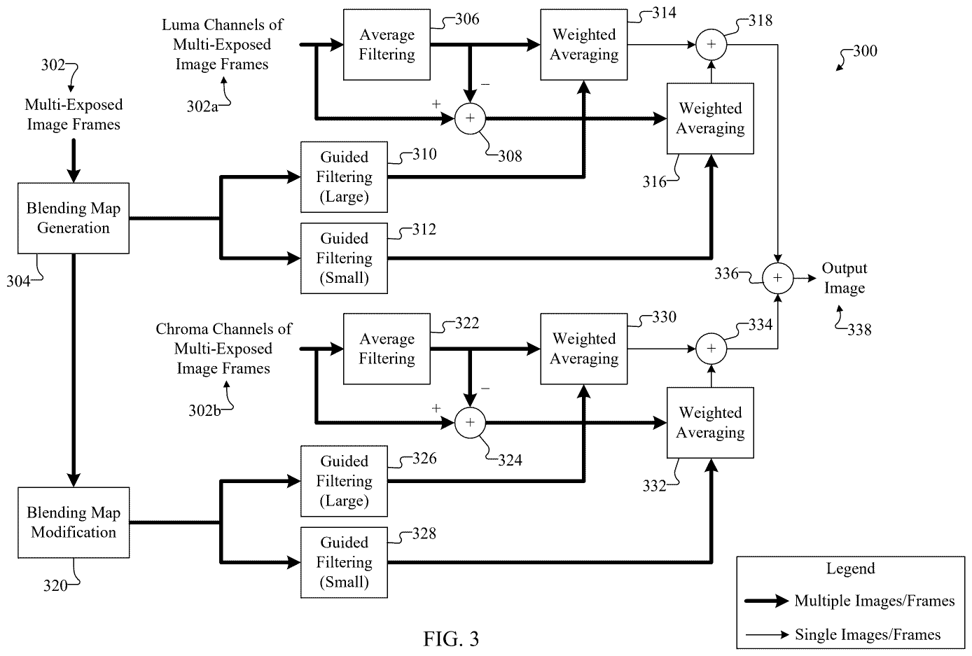

FIG. 3 illustrates a first example architecture 300 for color distortion-aware exposure fusion in accordance with this disclosure. For ease of explanation, the architecture 300 shown in FIG. 3 is described as being used by the electronic device 101 in the network configuration 100 shown in FIG. 1 in order to implement at least part of the tone mapping operation 210 (such as the fusion operation 256) shown in FIGS. 2A and 2B. However, the architecture 300 may be used with any other suitable device(s) (such as the server 106) or pipeline(s) and in any other suitable system(s). In FIG. 3, note that thicker lines are used to denote multiple images or image frames and thinner lines are used to denote single images or image frames.

As shown in FIG. 3, multiple multi-exposed image frames 302 are obtained, where different ones of the multi-exposed image frames 302 are associated with different exposures. The multi-exposed image frames 302 may, for example, represent the synthetic-exposure image frames 254. In some embodiments, each multi-exposed image frame 302 includes a luma channel and multiple chroma channels, meaning there is pixel data in a luma channel and pixel data in different chroma channels. In some cases, the pixel data of each multi-exposed image frame 302 may be denoted as (Y,Cb,Cr) or YCbCr, where Y represents the luma (luminance) channel data and Cb and Cr represent the chroma (blue-difference chrominance and red-difference chrominance) channel data.

The multi-exposed image frames 302 are provided to a blending map generation operation 304, which generally operates to produce one or more initial blending maps for the multi-exposed image frames 302. In some embodiments, the blending map generation operation 304 can produce an initial blending map for each multi-exposed image frame 302, where each initial blending map identifies initial contributions of pixel values in the associated multi-exposed image frame 302 to a final output image. The blending map generation operation 304 can use any suitable technique(s) to generate initial blending maps for multi-exposed image frames 302.

In some embodiments, consider the i^{th} multi-exposed image frame 302 in a set of multi-exposed image frames 302, where the i^{th} multi-exposed image frame 302 is associated with a lower exposure (such as a shorter exposure time). All other things being equal, image details in any darker region of the i^{th} multi-exposed image frame 302 are more likely to be poor or nonexistent due to the shorter exposure time, while image details in any brighter regions of the i^{th} multi-exposed image frame 302 are more likely to exhibit good color saturation and not be blown out or over-saturated. Thus, within an initial blending map for the i^{th} multi-exposed image frame 302, the blending map generation operation 304 could assign higher weights to brighter regions of the image frame than to darker regions of the image frame. In this way, the contribution of the best-exposed portions of the image frame to the final output image could be greater than the contribution of the poorly-exposed portions of the image frame.

In particular embodiments, the blending map generation operation 304 may operate as follows. For each i^{th} multi-exposed image frame 302, the initial blending map generated by the blending map generation operation 304 for that image frame 302 may include or be based on a composite of at least (i) a first map of values of a contrast or saliency metric C and (ii) a second map of values of a color saturation metric S. In this example, the values of the contrast or saliency metric C can correspond to the extent to which a given region of the 7th image frame exhibits sufficient contrast from which edge details can be perceived. Also, in this example, the values of the color saturation metric S can correspond to color saturation, such as whether colors in a particular region of the i^{th} image frame appear deep or “blown out” and almost white. As a particular example, a first map Cᵢ of the saliency metric C for the i^{th} image frame may be obtained as follows.

$${C}_{i} = ( {Y}_{i} * L ) * G$$

Here, Yᵢ represents the luma channel of the i^{th} image frame, L represents a Laplacian operator, and G represents a Gaussian filter. As another particular example, where image data for the i^{th} image frame is provided through the channels of the YCbCr color space, a second map Si of the color saturation metric S for the i^{th} image frame may be obtained as follows.

$${S}_{i} = {( C {b}_{i} - 128 )}^{2} + {( C {r}_{i} - 128 )}^{2}$$

Here, Cbᵢ represents the Cb chroma channel of the i^{th} image frame, and Crᵢ represents the Cr chroma channel of the i^{th} image frame. In some cases, an initial blending map Pᵢ for the i^{th} image frame may be generated by combining and normalizing the first and second maps, which could be expressed as follows.

$${\tilde{P}}_{i} = {C}_{i} * {S}_{i} {P}_{i} = \frac{{\tilde{P}}_{i}}{{Σ}_{i = I}^{N} {\tilde{P}}_{i}}$$

Here, \tilde{P}ᵢ represents the combined maps, Pᵢ represents the combined maps after normalization, and N represents the number of multi-exposed image frames 302. These operations may be repeated for each image frame so that an initial blending map P is generated for each image frame. In this way, Pᵢ represents channel-agnostic initial blending weights, which can be refined to properly register with object boundaries within a scene.

Luma channels 302a of the multi-exposed image frames 302 can be processed using a set of operations to produce a fused luma image based on the multi-exposed image frames 302 and the blending maps. For example, each of the luma channels 302a of the multi-exposed image frames 302 can be decomposed into a base layer and a detail layer. In some embodiments, image data of the luma channel 302a of each image frame 302 can be represented as a superposition or sum of a base layer and a detail layer. A “base layer” refers to an image layer that includes large-scale (such as lower frequency) variations in values of a channel of image data, and a “detail layer” refers to an image layer that includes small-scale (such as higher frequency relative to the base layer) variations in values of the channel of image data. In this example, the luma channels 302a of the multi-exposed image frames 302 can be processed using an average filtering operation 306, which can filter pixel values of the luma channel 302a of each multi-exposed image frame 302. A difference operation 308 calculates differences between the luma channels 302a of the multi-exposed image frames 302 and the associated average/filtered luma channels 302a of the multi-exposed image frames 302. Here, the outputs of the average filtering operation 306 represent the base layers of the luma channels 302a, and the outputs of the difference operation 308 represent the detail layers of the luma channels 302a.

In some embodiments, the image data forming the luma channel 302a of the 7th image frame 302 may be expressed as follows.

$${Y}_{i} = {YD}_{i} + {YB}_{i}$$

Here, Yᵢ represents a sum of the detail layer YD; and the base layer YBᵢ. Thus, the detail layer YDᵢ can be obtained by subtracting the base layer YBᵢ from the original channel image data Yᵢ as follows.

$${YD}_{i} = {Y}_{i} - {YB}_{i}$$

In particular embodiments, the base layer for the i^{th} image frame can be obtained by applying a box filter (such as boxfilt or imboxfilt in MATLAB) to the luma channel 302a of the i^{th} image frame. For example, the base layer YBᵢ of the Y channel of the i^{th} image frame could be obtained as follows.

$${YB}_{i} = boxfilt ( {Y}_{i} , θ )$$

Here, θ is a parameter setting the size or kernel of the box filter. In some cases, the value of θ can be tuned to optimize the quality of images produced by the architecture 300. From this, the detail layer YDᵢ can be obtained by subtracting the base layer YBᵢ from Yᵢ. The base and detail layers of the luma channel 302a for each of the multi-exposed image frames 302 can be generated in this manner.

In many cases, the initial blending maps Pᵢ produced by the blending map generation operation 304 are noisy, and transitions in blending weights can be spatially inconsistent relative to the boundaries of objects in a scene captured in the multi-exposed image frames 302. In practical terms, if the final output image is formed by blending image frames based on the initial blending maps, the weighting values for a given image frame or image frame channel may not register precisely with object boundaries within the scene, producing regions of improper exposures around the boundaries between brighter and darker areas of the scene. Left uncorrected, these registration errors can appear in the final output image as (i) light halos in which high weighting given to a higher-exposure image frame to bring out detail in a darker region spills over to a brighter region and/or (ii) dark halos in which high weighting given to a lower-exposure image frame to preserve detail in a brighter region spills over to a darker region.

In order to help compensate for these registration errors, one or more filters, such as one or more guided filters, can be applied to the blending maps from the blending map generation operation 304. In this example, a guided filtering operation 310 can apply a larger kernel to the blending maps from the blending map generation operation 304, and a guided filtering operation 312 can apply a smaller kernel to the blending maps from the blending map generation operation 304. The guided filtering operation 310 processes the blending maps using the larger kernel to produce first filtered blending maps, which are provided to a weighted averaging operation 314. The weighted averaging operation 314 applies the first filtered blending maps to the base layers of the multi-exposed image frames 302 in order to fuse the base layers of the multi-exposed image frames 302, and the weighted averaging operation 314 outputs a fused base layer for the multi-exposed image frames 302. Similarly, the guided filtering operation 312 processes the blending maps using the smaller kernel to produce second filtered blending maps, which are provided to a weighted averaging operation 316. The weighted averaging operation 316 applies the second filtered blending maps to the detail layers of the multi-exposed image frames 302 in order to fuse the detail layers of the multi-exposed image frames 302, and the weighted averaging operation 316 outputs a fused detail layer for the multi-exposed image frames 302. A combination operation 318 combines the fused base layer and the fused detail layer to produce a fused luma image for the multi-exposed image frames 302.

The guided filtering operations 310 and 312 here can perform guided filtering of the blending maps with guidance from the multi-exposed image frames 302 so that the filtered blending maps preserve edge and gradient information from the multi-exposed image frames 302. In some embodiments, for each of the blending maps Pᵢ generated by the blending map generation operation 304, alignment of blending weights relative to object boundaries can be enhanced by applying one or more guided filters operating as one or more edge-preserving filters, where each guided filter has a specified kernel size governing the size of the image frame area processed by the guided filter. The guided filtering operation 310 uses a larger kernel (such as 25×25) that is applied to each initial blending map Pᵢ to obtain, for the luma channel 302a of each multi-exposed image frame 302, a blending weight map WB; for the base layer. The data Yᵢ of the luma channel 302a of each multi-exposed image frame 302 can be used as a guiding image for the guided filtering operation 310. The guided filtering operation 312 uses a smaller kernel (such as 5×5) that is applied to each initial blending map Pᵢ to obtain, for the luma channel 302a of each multi-exposed image frame 302, a blending weight map WDi for the detail layer. Again, the data Yᵢ of the luma channel 302a of each multi-exposed image frame 302 can be used as a guiding image for the guided filtering operation 312.

In this example, the weights applied to the luma channels 302a of the multi-exposed image frame 302 can be said to represent first weights. In a similar manner, chroma channels 302b of the multi-exposed image frames 302 can be processed using a set of operations to produce at least one fused chroma image based on the multi-exposed image frames 302 and the blending maps, where the weights applied to the chroma channels 302b of the multi-exposed image frame 302 can be said to represent second weights. In this example, the second weights are generated in a similar manner as for the luma channels 302a, but the blending maps produced by the blending map generation operation 304 are first modified using a blending map modification operation 320. The blending map modification operation 320 can process the blending maps produced by the blending map generation operation 304, possibly along with the multi-exposed image frames 302 or other information, in order to modify at least some of the weights in the blending maps to generate modified blending maps for the chroma channels 302b of the multi-exposed image frame 302. In this way, it is possible to adjust the colors within the multi-exposed image frame 302 by controlling how the chroma channels 302b are blended without making identical adjustments to the brightness (luma channels 302a) within the multi-exposed image frame 302.

The chroma channels 302b of the multi-exposed image frame 302 are provided to an average filtering operation 322 and a difference operation 324, which respectively generate base and detail layers of the chroma channels 302b of the multi-exposed image frame 302. The modified blending maps produced by the blending map modification operation 320 are provided to a guided filtering operation 326 that uses a larger kernel and a guided filtering operation 328 that uses a smaller kernel. A weighted averaging operation 330 fuses the base layers based on filtered blending maps generated by the guided filtering operation 326, and a weighted averaging operation 332 fuses the detail layers based on filtered blending maps generated by the guided filtering operation 328. A combination operation 334 combines the fused base layer(s) and the fused detail layer(s) to produce at least one fused chroma image for the multi-exposed image frames 302. These operations 322-334 can be performed in the same or similar manner as the operations 306-318 described above. In some cases, the operations 322-334 can be used to form multiple fused chroma images, such as a fused chroma image for the Cb channel and a fused chroma image for the Cr channel. In other cases, the operations 322-334 can be used to form a single fused chroma image for both chroma channels. A combination operation 336 combines the fused luma image and the at least one fused chroma image for the multi-exposed image frames 302 to produce an output image 338, which in some cases could represent the output image 212.

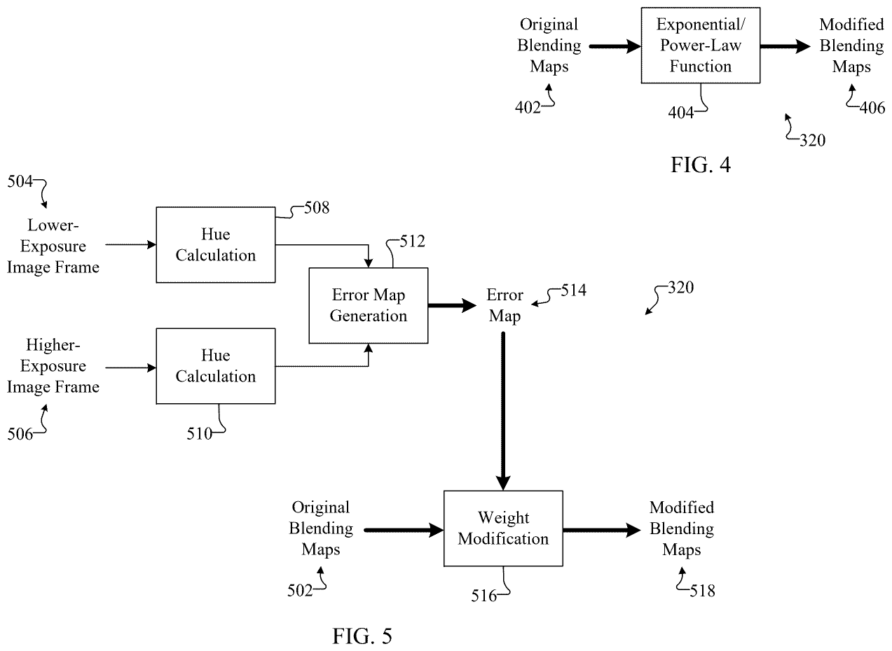

There are various ways in which the blending map modification operation 320 may be implemented in order to modify the blending weights for the luma channels 302a for use with the chroma channels 302b. FIGS. 4 and 5 illustrate example techniques for modifying blending maps in the architecture 300 of FIG. 3 in accordance with this disclosure. As shown in FIG. 4, the blending map modification operation 320 receives original blending maps 402, which represent the blending maps produced by the blending map generation operation 304. The blending map modification operation 320 applies an exponential or power-law function 404 to the weights of the original blending maps 402 in order to produce modified blending maps 406. The exponential or power-law function 404 here can reduce certain weights (such as smaller weights) and/or increase certain weights (such as larger weights) contained in the original blending maps 402. As a result, the weights in the modified blending maps 406 can favor the chroma channels 302b of certain multi-exposed image frames 302 (such as lower-exposure image frames) over the chroma channels 302b of other multi-exposed image frames 302 (such as higher-exposure image frames).

As a particular example of this, assume that the original blending maps 402 for N multi-exposed image frames 302 as denoted as follows.

$${W}_{i} for i = 0 , 1 , … , N - 1 .$$

Here, index 0 could represent the image frame 302 with the lowest exposure, and index N−1 could represent the image frame 302 with the highest exposure. The exponential or power-law function 404 can modify the weights of the original blending maps 402 to produce the modified blending maps 406, which can be denoted as follows.

$${\tilde{W}}_{i} for i = 0 , 1 , … , N - 1 .$$

Here, \tilde{W}ᵢ represents the i^{th} modified blending map 406. In some cases, the exponential or power-law function 404 can apply the following function to generate the modified blending maps 406.

$${\tilde{W}}_{i} = \frac{{W}_{i}^{{p}_{i}}}{{Σ}_{j = 0}^{N - 1} {W}_{j}^{{p}_{j}}}$$

Here, pᵢ represents an exponent applied to the i^{th} original blending map 402 (denoted Wᵢ), and pⱼ represents an exponent used in a summation to normalize the result obtained by applying the exponent pᵢ. The exponents pᵢ are tunable, and p₀<p₁< . . . <p_{N-1}. In some embodiments, typical values of pᵢ could be between one and five. Raising weights related to larger exposures to an exponential power reduces the resulting modified weights heavily, such as for regions where the weights are already not high compared to other exposures. This helps to ensure that brighter regions (where the higher exposures have color distortions) do not contribute significantly to final blending weights for the chroma channels and instead favor lower exposures to obtain chroma channel weights. Note that by using the blending map modification operation 320 to modify the weights associated with the chroma channels 302b, it is possible to apply separate corrections to the chroma channels 302b without making similar corrections to the luma channels 302a.

As shown in FIG. 5, the blending map modification operation 320 again receives original blending maps 502, which represent the blending maps produced by the blending map generation operation 304. The blending map modification operation 320 also receives pairs of the multi-exposed image frames 302, namely a lower-exposure image frame 504 and a higher-exposure image frame 506. Hue calculation functions 508 and 510 generally operate to determine hue maps for the image frames 504 and 506. In some cases, each hue map could identify a hue of various pixels within the corresponding image frame 504 or 506. Each hue calculation function 508 and 510 can use any suitable technique(s) to identify hue in an image frame, such as by performing hue/saturation/value (HSV) color-space transformation or by calculating a hue angle in a YCbCr transformation. The hue maps are provided to an error map generation function 512, which generally operates to compare the hue maps (such as by calculating pixel-wise differences between the hue maps) and generate an error map 514 identifying the differences between the hue maps for that pair of multi-exposed image frames 302. These differences are indicative of color distortions in at least one of the two image frames 302 in the pair. A weight modification function 516 modifies the original blending map 502 corresponding to one of the two image frames 302 (such as the higher-exposure image frame 506) using the error map 514 to generate a modified blending map 518. For example, the weight modification function 516 can modify weights from the original blending map 502 so that weights in the modified blending map 518 favor the lower-exposure image frame 504 during blended. Note that this can be done for each of the image frames 302, such as when a lowest-exposure image frame 504 is compared to each higher-exposure image frame 506 in the set of image frames 302 in order to modify the blending map for each higher-exposure image frame 506.

As a particular example of this, the modified blending maps 518 can be calculated as follows.

$${\tilde{W}}_{i} = G F ( ( 1 - ( {e}_{i} ) ) * {W}_{i} )$$

Here, GF represents a guided filtering function, and et represents the hue error in the error map 514. In some cases, the hue error eᵢ can be defined as follows.

$${e}_{i} = GF ( sigmoid ( modulo ( {H}_{I} - {H}_{O} , 360 ) , {T}_{1} ) * sigmoid ( {Y}_{i} , {T}_{2} )$$

Here, T₁ and T₂ represent tunable thresholds, Yᵢ represents luma channel data, Hₒ represents the hue map for the lower-exposure image frame 504, and H₁ represents the hue map for the higher-exposure image frame 506.

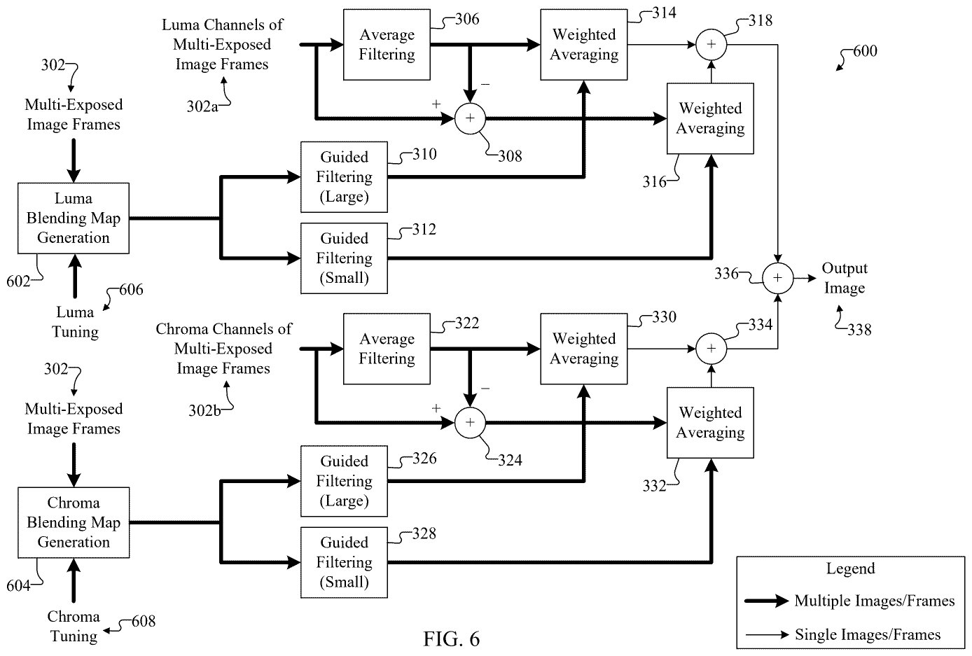

FIG. 6 illustrates a second example architecture 600 for color distortion-aware exposure fusion in accordance with this disclosure. For ease of explanation, the architecture 600 shown in FIG. 6 is described as being used by the electronic device 101 in the network configuration 100 shown in FIG. 1 in order to implement at least part of the tone mapping operation 210 (such as the fusion operation 256) shown in FIGS. 2A and 2B. However, the architecture 600 may be used with any other suitable device(s) (such as the server 106) or pipeline(s) and in any other suitable system(s). In FIG. 6, note that thicker lines are used to denote multiple images or image frames and thinner lines are used to denote single images or image frames. The architecture 600 shown in FIG. 6 is similar to the architecture 300 shown in FIG. 3, and only the differences between the two are discussed below.

As shown in FIG. 6, the blending map generation operation 304 and the blending map modification operation 320 have been replaced with a luma blending map generation operation 602 and a chroma blending map generation operation 604. The luma blending map generation operation 602 processes the multi-exposed image frames 302 and one or more luma tuning parameters 606 to generate initial blending maps for the luma channels 302a of the multi-exposed image frames 302. Similarly, the chroma blending map generation operation 604 processes the multi-exposed image frames 302 and one or more chroma tuning parameters 608 to generate initial blending maps for the chroma channels 302b of the multi-exposed image frames 302.

Both of the blending map generation operations 602 and 604 may operate in a similar manner as the blending map generation operation 304 described above. For example, each of the blending map generation operations 602 and 604 may determine, for each i^{th} multi-exposed image frame 302, a composite of (i) a first map of values of a contrast or saliency metric C and (ii) a second map of values of a color saturation metric S. These metrics are defined above with respect to FIG. 3. However, the one or more luma tuning parameters 606 can differ from the one or more chroma tuning parameters 608. For instance, the one or more chroma tuning parameters 608 can cause the chroma blending map generation operation 604 to use higher weights with respect to lower-exposure image frames 302 when generating the composite values.

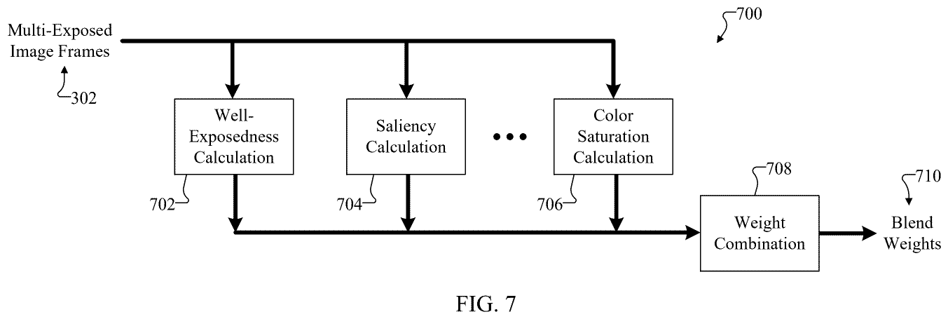

FIG. 7 illustrates an example technique 700 for identifying blending weights for chroma channels 302b in the architectures 300 and 600 of FIGS. 3 and 6 in accordance with this disclosure. For example, the technique 700 could be used by the chroma blending map generation operation 604 to generate initial blending weight maps for the chroma channels 302b of the multi-exposed image frames 302. For ease of explanation, the technique 700 shown in FIG. 7 is described as being used by the electronic device 101 in the network configuration 100 shown in FIG. 1. However, the technique 700 may be used with any other suitable device(s) (such as the server 106) and in any other suitable system(s).

As shown in FIG. 7, the multi-exposed image frames 302 are received and processed using multiple weight calculation functions 702-706. The weight calculation functions 702-706 are used to generate different initial weights for each of at least some of the image frames 302. For example, the weight calculation function 702 can be used to calculate well-exposedness weights for each image frame 302, where the well-exposedness weights are based on whether pixels in the image frames 302 are over-exposed, well-exposed, or under-exposed. The weight calculation function 704 can be used to calculate saliency weights for each image frame 302, where the saliency weights are based on contrasts of the pixels in the image frames 302. The weight calculation function 706 can be used to calculate color saturation weights for each image frame 302, where the color saturation weights are based on levels of color saturation of the pixels in the image frames 302. A weight combination function 708 can combine the weights (such as per pixel) as determined by the weight calculation functions 702-706 in order to generate blend weights 710 for the chroma channels 302b of the multi-exposed image frames 302. Note that at least the weight calculation function 706 could be used in FIG. 3 as part of the blending map modification operation 320, where the blending map modification operation 320 modifies weights of the blending maps from the blending map generation operation 304 based on color saturations of pixels in the image frames 302 as determined using the weight calculation function 706.

As part of this process, the blend weights 710 can be determined in a manner that favors the lower-exposure image frames for pixels with saturated colors, reducing contribution by the higher-exposure image frames for those pixels. In some embodiments, to identify pixels with color saturation, RGB pixel values can be analyzed. For instance, pixels with color saturation may often have RGB values in which the largest of the RGB values is much greater than the smallest of the RGB values.

As a particular example of this, for each pixel in each image frame 302, the largest of the pixel's RGB values max(R,G,B) and the smallest of the pixel's RGB values min(R,G,B) can be identified. If the image frame 302 is not in the RGB color space, the image frame 302 can be converted to this color space in order to identify max(R,G,B) and min(R,G,B) for each pixel. The saturation level Lₛₐₜ for each pixel can be calculated as follows.

$${L}_{sat} ( R , G , B ) = {f}_{max} ( max ( R , G , B ) ) * {f}_{min} ( min ( R , G , B ) )$$

In some embodiments, the functions ƒₘₐₓ and ƒₘᵢₙ could be defined as follows.

$${f}_{max} ( x ) = \{ \begin{matrix}{e}^{- \frac{{( x - {μ}_{max} )}^{2}}{2 {σ}_{max}^{2}}} , & x < {μ}_{max} \\ 1 , & otherwise\end{matrix}$$

$${f}_{min} ( x ) = \{ \begin{matrix}{e}^{- \frac{{( x - {μ}_{min} )}^{2}}{2 {σ}_{min}^{2}}} , & x > {μ}_{min} \\ 1 , & otherwise\end{matrix}$$

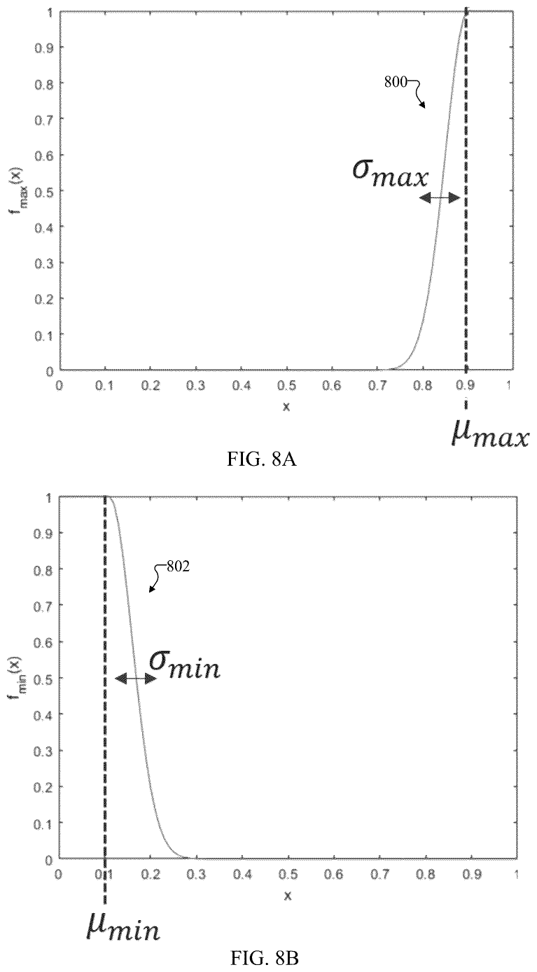

Here, μₘₐₓ and μₘᵢₙ respectively represent the means of the maximum and minimum RGB values, and σₘₐₓ² and σₘᵢₙ² respectively represent the variances of the maximum and minimum RGB values. FIGS. 8A and 8B illustrate example curves 800 and 802 for identifying color saturation weights in the architectures 300 and 600 of FIGS. 3 and 6 in accordance with this disclosure. More specifically, FIG. 8A illustrates an example curve for ƒₘₐₓ, and FIG. 8B illustrates an example curve ƒₘᵢₙ. When multiple exposures are present, a saturation level at each exposure i can be expressed as Lₛₐₜ (i) and may be calculated as described above. The saturation levels can be used to calculate a saturation weight Wₛₐₜ (i), which can represent the output of the weight calculation function 706. In some cases, the saturation weight Wₛₐₜ (i) can be expressed as follows.

$${W}_{sat} ( k ) = \{ \begin{matrix}1 , k = 0 \\ 1 - {\prod }_{j = 0}^{k - 1} {L}_{sat} ( j ) , otherwise\end{matrix}$$

In some cases, the weight combination function 708 can calculate the blend weights 710 as follows.

$${W}_{b l e n d} ( k ) = {W}_{1} ( k ) * {W}_{2} ( k ) * … * {W}_{sat} ( k )$$

Here, W₁ (k), W₂ (k), . . . represent weights determined by other weight calculation functions 702-704.

Although FIGS. 3 through 8 illustrate examples of architectures 300 and 600 for color distortion-aware exposure fusion and related details, various changes may be made to FIGS. 3 through 8. For example, various components, operations, or functions in each of FIGS. 3 through 8 may be combined, further subdivided, replicated, omitted, or rearranged and additional components, operations, or functions may be added according to particular needs. Also, while components 306-318 and components 322-334 are shown as being separate components in the architectures 300 and 600, it is possible to use the same components repeatedly (such as serially) to generate the fused luma and fused chroma images. Similarly, while multiple instances of the hue calculation functions 508-510 are shown in FIG. 5, the same hue calculation function may be used repeatedly (such as serially) to generate hue maps.

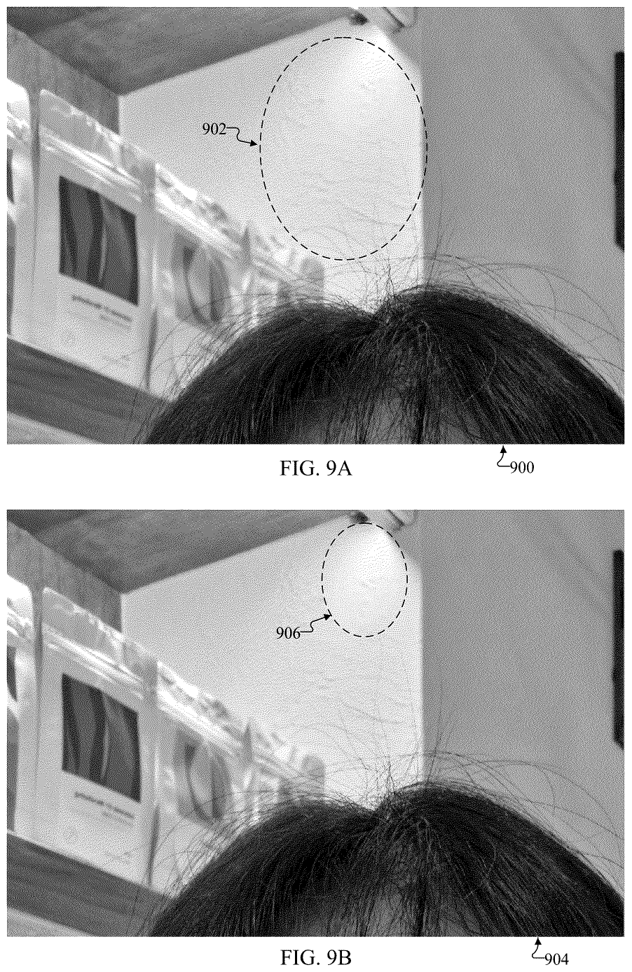

FIGS. 9A and 9B illustrate example results obtainable using color distortion-aware exposure fusion in accordance with this disclosure. More specifically, FIG. 9A illustrates an example output image 900 generated without color distortion-aware exposure fusion. As can be seen here, the output image 900 has a large area 902 of color distortion created as a result of bright illumination from a light source in a scene. FIG. 9B illustrates an example output image 904 generated with adaptive multi-stage super-resolution as described above. As can be seen here, the output image 904 has a much smaller area 906 of color change, which is consistent with the bright illumination from the light source. However, there is not a large area of color distortion surrounding the smaller area 906.

Note that other or additional types of benefits can also be obtained using color distortion-aware exposure fusion. For example, if the wall in the background of the scene in FIGS. 9A and 9B included a neon sign, the output image 900 could have duller or washed-out colors that appear somewhat hazy, which is due to color saturation. However, using the techniques described above, the same neon sign in the output image 904 would have more-vibrant colors and appear clearer. This is due to the use of blending weights that favor pixels from lower-exposure image frames over pixels from higher-exposure image frames during blending, since the higher-exposure pixels are more likely to suffer from color saturation.

Although FIGS. 9A and 9B illustrate one example of results obtainable using color distortion-aware exposure fusion, various changes may be made to FIGS. 9A-9B. For example, FIGS. 9A-9B are merely meant to illustrate one example of a type of benefit that might be obtained using the techniques of this disclosure. The specific results that are obtained in any given situation can vary based on the circumstances and based on the specific implementation of the techniques described in this disclosure.

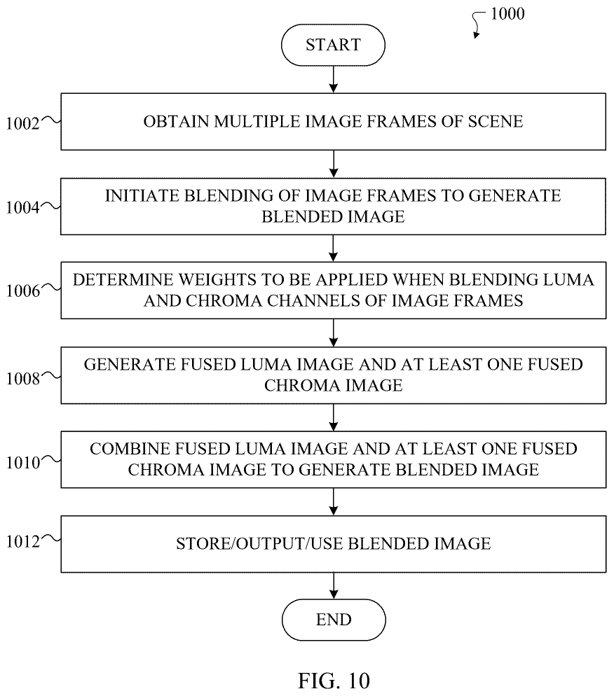

FIG. 10 illustrates an example method 1000 for color distortion-aware exposure fusion in accordance with this disclosure. For ease of explanation, the method 1000 shown in FIG. 10 is described as being performed by the electronic device 101 in the network configuration 100 shown in FIG. 1, where the electronic device 101 can implement the pipeline 200 shown in FIGS. 2A and 2B and include one of the architectures 300 and 600 shown in FIGS. 3 through 8. However, the method may be performed using any other suitable device(s) (such as the server 106), pipeline(s), or architecture(s) and in any other suitable system(s).

As shown in FIG. 10, multiple image frames of a scene are obtained at step 1002. This may include, for example, the processor 120 of the electronic device 101 generating or otherwise obtaining multiple multi-exposed image frames 302. In some cases, the multiple multi-exposed image frames 302 may be generated by performing one or more synthetic exposure generation operations 252 using a multi-exposed image 250, such as a linear or other HDR image, to generate multiple synthetic-exposure image frames 254. Each multi-exposed image frame 302 includes a luma channel and chroma channels.

Blending of the image frames to generate a blended image is initiated at step 1004. This may include, for example, the processor 120 of the electronic device 101 initiating processing of the multi-exposed image frames 302 using the architecture 300 or 600. As part of the blending process, weights to be applied when blending the luma and chroma channels of the image frames are determined at step 1006. This may include, for example, the processor 120 of the electronic device 101 determining first weights to be applied when blending the luma channels 302a of the image frames 303 and separate second weights to be applied when blending the chroma channels 302b of the image frames 302.

As noted above, there are various ways in which the first and second weights can be determined. In some embodiments, the first weights may be determined based on the image frames 302, and the first weights may be modified to generate the second weights. As a particular example, the first weights can be modified by applying an exponential or power-law function 404 to weights of original blending maps 402 in order to produce modified blending maps 406. The exponential or power-law function 404 can reduce first ones of the first weights and/or increase second ones of the first weights, where the first ones of the first weights have smaller values than the second ones of the first weights. The exponential or power-law function 404 causes the second weights, compared to the first weights, to favor the chroma channels 302b of one or more first ones of the image frames 302 over the chroma channels 302b of one or more second ones of the image frames 302 during the blending of the image frames 302, where the one or more first ones of the image frames 302 having a lower exposure than the one or more second ones of the image frames 302. As another particular example, the first weights can be modified by determining error maps 514 based on hues of pairs of the image frames 302 (where one of the two image frames 302 has a lower exposure than another of the two image frames 302), and the first weights can be modified based on the error maps 514.

In other embodiments, the first weights and the second weights can be determined separately, such as by determining the first weights using one or more luma tuning parameters 606 and separately determining the second weights using one or more chroma tuning parameters 608. The one or more chroma tuning parameters 608 can be different than the one or more luma tuning parameters 606. In some cases, the second weights can be generated by determining different initial weights for the image frames 302, where the different initial weights are associated with different characteristics of the image frames 302. For instance, the weight calculation functions 702-706 can be used to generate the initial weights of the image frames 302, such as initial weights based on well-exposedness, saliency, and color saturation. The different initial weights for the image frames can be combined to generate the second weights, such as by using the weight combination function 708 to calculate blend weights 710. In some cases, the different initial weights for the image frames 302 can include color saturation weights associated with the image frames 302, where the color saturation weights are based on amounts of color saturation within the image frames 302. When combining the initial weights, certain ones of the initial weights that are associated with larger amounts of color saturation within the image frames 302 can be reduced, and/or other certain ones of the initial weights that are associated with smaller amounts of color saturation within the image frames 302 can be increased.

In various embodiments, the image frames 302 include at least one lower-exposure image frame and at least one higher-exposure image frame. The second weights can be determined so that, during the blending of the image frames 302, (i) the contribution of the chroma channels 302b of the at least one lower-exposure image frame 302 is increased and/or (ii) the contribution of the chroma channels 302b of the at least one higher-exposure image frame 302 is decreased. This may, for example, help to reduce or avoid issues with color saturation since the at least one lower-exposure image frame 302 likely has less over-saturation compared to the at least one higher-exposure image frame 302.

A fused luma image and at least one fused chroma image are generated at step 1008. This may include, for example, the processor 120 of the electronic device 101 generating the fused luma image using the luma channels 302a of the image frames 302 and the first weights. This may also include the processor 120 of the electronic device 101 separately generating the at least one fused chroma image using the chroma channels 302b of the image frames 302 and the second weights. The fused luma image and the at least one fused chroma image are combined to generate the blended image at step 1010. This may include, for example, the processor 120 of the electronic device 101 combining the fused luma image and the at least one fused chroma image into a single output image 212, 338.

The blended image can be stored, output, or used in some manner at step 1012. For example, the output image 212, 338 may be displayed on the display 160 of the electronic device 101, saved to a camera roll stored in a memory 130 of the electronic device 101, or attached to a text message, email, or other communication to be transmitted from the electronic device 101. As another example, multiple output images 212, 338 could be generated and used to form a video sequence, which again can be displayed on the display 160 of the electronic device 101, saved to the camera roll stored in the memory 130 of the electronic device 101, or attached to the text message, email, or other communication to be transmitted from the electronic device 101. Of course, the output image 212, 338 could be used in any other or additional manner.

Although FIG. 10 illustrates one example of a method 1000 for color distortion-aware exposure fusion, various changes may be made to FIG. 10. For example, while shown as a series of steps, various steps in FIG. 10 may overlap, occur in parallel, occur in a different order, or occur any number of times (including zero times).

It should be noted that the functions shown in or described with respect to FIGS. 2 through 10 can be implemented in an electronic device 101, 102, 104, server 106, or other device(s) in any suitable manner. For example, in some embodiments, at least some of the functions shown in or described with respect to FIGS. 2 through 10 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 10 can be implemented or supported using dedicated hardware components. In general, the functions shown in or described with respect to FIGS. 2 through 10 can be performed using any suitable hardware or any suitable combination of hardware and software/firmware instructions. Also, the functions shown in or described with respect to FIGS. 2 through 10 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple image frames of a scene, wherein each image frame comprises a luma channel and chroma channels; and
blending, using the at least one processing device, the image frames to generate a blended image, wherein blending the image frames comprises:
determining first weights to be applied when blending the luma channels of the image frames and separate second weights to be applied when blending the chroma channels of the image frames;
generating a fused luma image using the luma channels of the image frames and the first weights and separately generating at least one fused chroma image using the chroma channels of the image frames and the second weights; and
combining the fused luma image and the at least one fused chroma image.

2. The method of claim 1, wherein determining the first weights and the second weights comprises:
determining the first weights based on the image frames; and
modifying the first weights to generate the second weights.

3. The method of claim 2, wherein:
modifying the first weights comprises applying an exponential or power-law function to the first weights in order to generate the second weights, the exponential or power-law function at least one of: reducing first ones of the first weights or increasing second ones of the first weights, the first ones of the first weights having smaller values than the second ones of the first weights; and
the exponential or power-law function causes the second weights, compared to the first weights, to favor the chroma channels of one or more first ones of the image frames over the chroma channels of one or more second ones of the image frames during the blending of the image frames, the one or more first ones of the image frames having a lower exposure than the one or more second ones of the image frames.

4. The method of claim 2, wherein modifying the first weights comprises:
determining error maps based on hues of pairs of the image frames, wherein, in each pair of the image frames, one of the image frames in the pair has a lower exposure than another of the image frames in the pair; and
modifying the first weights based on the error maps.

5. The method of claim 1, wherein determining the first weights and the second weights comprises:
determining the first weights using one or more first tuning parameters; and
separately determining the second weights using one or more second tuning parameters, the one or more second tuning parameters different than the one or more first tuning parameters.

6. The method of claim 5, wherein determining the second weights using the one or more second tuning parameters comprises:
determining different initial weights for the image frames, the different initial weights associated with different characteristics of the image frames; and
combining the different initial weights for the image frames to generate the second weights.

7. The method of claim 6, wherein:
the different initial weights for the image frames comprise color saturation weights associated with the image frames, the color saturation weights based on amounts of color saturation within the image frames; and
the different initial weights for the image frames are combined by at least one of: reducing ones of the initial weights that are associated with larger amounts of color saturation within the image frames or increasing others of the initial weights that are associated with smaller amounts of color saturation within the image frames.

8. The method of claim 1, wherein:
the image frames include at least one lower-exposure image frame and at least one higher-exposure image frame; and
the second weights are determined in order to, during the blending of the image frames, at least one of: (i) increase contribution of the chroma channels of the at least one lower-exposure image frame or (ii) decrease contribution of the chroma channels of the at least one higher-exposure image frame.

9. An electronic device comprising:
at least one processing device configured to:
obtain multiple image frames of a scene, wherein each image frame comprises a luma channel and chroma channels; and
blend the image frames to generate a blended image;
wherein, to blend the image frames, the at least one processing device is configured to:
determine first weights to be applied when blending the luma channels of the image frames and separate second weights to be applied when blending the chroma channels of the image frames;
generate a fused luma image using the luma channels of the image frames and the first weights and separately generate at least one fused chroma image using the chroma channels of the image frames and the second weights; and
combine the fused luma image and the at least one fused chroma image.

10. The electronic device of claim 9, wherein, to determine the first weights and the second weights, the at least one processing device is configured to:
determine the first weights based on the image frames; and
modify the first weights to generate the second weights.

11. The electronic device of claim 10, wherein:
to modify the first weights, the at least one processing device is configured to apply an exponential or power-law function to the first weights in order to generate the second weights, the exponential or power-law function at least one of: reducing first ones of the first weights or increasing second ones of the first weights, the first ones of the first weights having smaller values than the second ones of the first weights; and
the exponential or power-law function causes the second weights, compared to the first weights, to favor the chroma channels of one or more first ones of the image frames over the chroma channels of one or more second ones of the image frames during the blending of the image frames, the one or more first ones of the image frames having a lower exposure than the one or more second ones of the image frames.

12. The electronic device of claim 10, wherein, to modify the first weights, the at least one processing device is configured to:
determine error maps based on hues of pairs of the image frames, wherein, in each pair of the image frames, one of the image frames in the pair has a lower exposure than another of the image frames in the pair; and
modify the first weights based on the error maps.

13. The electronic device of claim 9, wherein, to determine the first weights and the second weights, the at least one processing device is configured to:
determine the first weights using one or more first tuning parameters; and
separately determine the second weights using one or more second tuning parameters, the one or more second tuning parameters different than the one or more first tuning parameters.

14. The electronic device of claim 13, wherein, to determine the second weights using the one or more second tuning parameters, the at least one processing device is configured to:
determine different initial weights for the image frames, the different initial weights associated with different characteristics of the image frames; and
combine the different initial weights for the image frames to generate the second weights.

15. The electronic device of claim 14, wherein:
the different initial weights for the image frames comprise color saturation weights associated with the image frames, the color saturation weights based on amounts of color saturation within the image frames; and
the at least one processing device is configured to combine the different initial weights for the image frames by at least one of: reducing ones of the initial weights that are associated with larger amounts of color saturation within the image frames or increasing others of the initial weights that are associated with smaller amounts of color saturation within the image frames.

16. The electronic device of claim 9, wherein:
the image frames include at least one lower-exposure image frame and at least one higher-exposure image frame; and
the at least one processing device is configured to determine the second weights in order to, during the blending of the image frames, at least one of: (i) increase contribution of the chroma channels of the at least one lower-exposure image frame or (ii) decrease contribution of the chroma channels of the at least one higher-exposure image frame.

17. A non-transitory machine readable medium containing instructions that when executed cause at least one processor of an electronic device to:
obtain multiple image frames of a scene, wherein each image frame comprises a luma channel and chroma channels; and
blend the image frames to generate a blended image;
wherein the instructions that when executed cause the at least one processor to blend the image frames comprise instructions that when executed cause the at least one processor to:
determine first weights to be applied when blending the luma channels of the image frames and separate second weights to be applied when blending the chroma channels of the image frames;
generate a fused luma image using the luma channels of the image frames and the first weights and separately generate at least one fused chroma image using the chroma channels of the image frames and the second weights; and
combine the fused luma image and the at least one fused chroma image.

18. The non-transitory machine readable medium of claim 17, wherein the instructions that when executed cause the at least one processor to determine the first weights and the second weights comprise instructions that when executed cause the at least one processor to:
determine the first weights based on the image frames; and
modify the first weights to generate the second weights.

19. The non-transitory machine readable medium of claim 18, wherein:
the instructions that when executed cause the at least one processor to modify the first weights comprise instructions that when executed cause the at least one processor to apply an exponential or power-law function to the first weights in order to generate the second weights;
the exponential or power-law function at least one of: reduces first ones of the first weights or increases second ones of the first weights, the first ones of the first weights having smaller values than the second ones of the first weights; and
the exponential or power-law function causes the second weights, compared to the first weights, to favor the chroma channels of one or more first ones of the image frames over the chroma channels of one or more second ones of the image frames during the blending of the image frames, the one or more first ones of the image frames having a lower exposure than the one or more second ones of the image frames.

20. The non-transitory machine readable medium of claim 18, wherein the instructions that when executed cause the at least one processor to modify the first weights comprise instructions that when executed cause the at least one processor to:
determine error maps based on hues of pairs of the image frames, wherein, in each pair of the image frames, one of the image frames in the pair has a lower exposure than another of the image frames in the pair; and
modify the first weights based on the error maps.
